(19) United States
(12) Patent Application Publication
(10) Pub. No.: US 2021/0189836 A1
(43) Pub. Date: Jun. 24, 2021

(54) MULTI-LOCATION VIRTUAL COLLABORATION, MONITORING, AND CONTROL

(71) Applicant: Halliburton Energy Services, Inc., Houston, TX (US)

(72) Inventors: Troy D. Bachman, III, Duncan, OK (US); Craig A. Sneed, Duncan, OK (US); Keith Edward Blaschke, Duncan, OK (US); Paul Lewis Mendenall, Duncan, OK (US); Charles Edward Neal, III, Duncan, OK (US); Derek Ray Williams, Duncan, OK (US); Stanley C. Combs, Comanche, OK (US); Derek J. Abel, Duncan, OK (US)

(21) Appl. No.: 17/053,677

(22) PCT Filed: Nov. 28, 2018
(86) PCT No.: PCT/US2018/062711

§ 371 Date: Nov. 6, 2020

Related U.S. Application Data
(60) Provisional application No. 62/682,408, filed on Jun. 8, 2018.
(60) Provisional application No. 62/682,391, filed on Jun. 8, 2018.
(60) Provisional application No. 62/682,341, filed on Jun. 8, 2018.
(60) Provisional application No. 62/682,358, filed on Jun. 8, 2018.
(60) Provisional application No. 62/682,374, filed on Jun. 8, 2018.

(51) Int. Cl. E21B 41/00; G06F 3/01; H04N 5/38; G06T 11/00; G05B 11/01; G06Q 10/10

(52) U.S. Cl. CPC E21B 41/00; G06F 3/011; H04N 5/38; G06T 11/00; G06Q 30/018; G06Q 10/103; G06T 2200/24; G06Q 10/101; G05B 11/01

(57) ABSTRACT

A virtual presence may be established to provide engagement with equipment and operators at a hydrocarbon recovery, exploration, operation, or services environments in order to reduce the expense associated with having knowledge experts, or other personnel, travel to and work at remote hydrocarbon recovery, exploration, operation, or services environments. For example, a wearable device may allow a user, such as a subject matter expert, at a virtual real time operation center to view data from equipment located at the site.

### TECHNICAL FIELD

The present disclosure relates generally to remote presence at a hydrocarbon recovery, exploration, operation or services environment and, more particularly, to a system for real time monitoring and control of surface equipment from an onsite control center or a remote location for a hydrocarbon recovery, exploration, operation or services environment.

### BACKGROUND

Knowledge experts in various technological fields often are needed temporarily at a hydrocarbon recovery, exploration, operation, or services environment sites (hereinafter “sites”). Such experts give advice, collaborate, and provide assistance in job design, job execution, job safety and general problem solving. The issue is that many drilling sites are in remote regions on land or offshore where it is difficult and expensive for a knowledge expert to be present, especially if the knowledge expert is needed for only a short time period or for a small project. Despite the expense, it is generally necessary for the knowledge expert to be physically present on site because the knowledge expert needs to see, hear, and interact with the equipment and the individuals involved with a given site. To date, hands on experience proved to be the most effective way for a knowledge expert to provide assistance at a site.

Even more, if the knowledge expert is needed at multiple sites, the expert will have to travel to each site individually. Not only is it expensive for the expert to travel to multiple locations, it could cause delays in production if the site cannot continue without the presence of the expert. A multi-location collaborative approach is needed to accommodate the limitations on a knowledge experts time and the available resources.

Additionally, oil field operators are tasked with the difficult job of paying attention to multiple pieces of equipment across a site. It is difficult to keep track of the key parameters of all equipment under the operator's responsibility while also operating the operations of the site.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a block diagram of an information collection, processing, and distribution system, according to one or more aspects of the present disclosure.

FIG. 2 is a perspective view of a role specific augmented reality eyewear device, according to one or more aspects of the present disclosure.

FIG. 3 is a block diagram of components within an augmented reality eyewear device, according to one or more aspects of the present disclosure.

FIG. 4 is a flow diagram of a method, according to one or more aspects of the present disclosure.

FIG. 5 is a perspective view of an illustrative environment in which the information collection, processing, and distribution system disclosed herein may be deployed, according to one or more aspects of the present disclosure.

FIG. 6 is a diagram of an example information handling system, according to one or more aspects of the present disclosure.

FIG. 7 is a diagram showing an exemplary embodiment of the system, according to one or more aspects of the present disclosure.

FIG. 8 is a flowchart of a multi-location virtual collaboration, monitoring, and control of one or more drilling operations for a site, according to one or more aspects of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

Illustrative embodiments of the present disclosure are described in detail herein. In the interest of clarity, not all features of an actual implementation are described in this specification. It will, of course, be appreciated that in the development of any such actual embodiment, numerous implementation specific decisions must be made to achieve developers' specific goals, such as compliance with system related and business related constraints, which will vary from one implementation to another. Moreover, it will be appreciated that such a development effort might be complex and time consuming, but would nevertheless be a routine undertaking for those of ordinary skill in the art having the benefit of the present disclosure. Furthermore, in no way should the following examples be read to limit, or define, the scope of the disclosure.

To reduce the expense associated with having knowledge experts, for example, an expert intermediary, work at remote sites, certain embodiments according to the present disclosure may be directed to systems and methods for virtual presence and engagement with equipment and personnel at sites. An expert intermediary may be a person, a processing system such as an information handling system, a robot, a mechanical system, or any other person or device that operates to perform one or more necessary functions or operations required by the site. Specifically, the disclosed embodiments are directed to systems and methods for enabling knowledge experts to be virtually present and engaged at a remote location at an interactive level that rivals being physically present. Also, the disclosed embodiments are directed to systems and methods for allowing remote data collection, monitoring, job design, and operation to be executed from one or more remote operation centers. Such methods may use various local and remotely enabled elements of data communications, data sharing, job monitoring, job control, teleconferencing, camera feeds, audio feeds, data acquisition, control systems, and operator heads up displays.

Also, such methods may use several existing and potentially new technologies to achieve these goals. Teleconferencing, live video and audio streaming, data sharing, and remote network access already exist in several industries. What does not exist is a cohesive, integrated combination of these technologies that is targeted toward providing expert driven remote site assistance or delivering high quality well service at sites that may be either remote land locations or remote offshore locations. Such technology may include heads up displays with augmented reality and live network connections to other coworkers and off site experts. Such technology also may include body and area cameras and microphones that provide live video and audio on site and off site.

Also disclosed herein are methods and systems for facilitating the seamless and real time collection, processing, and distribution of information using augmented reality devices. In embodiments, a controller for instance, a computer wirelessly communicates with and controls multiple eyewear devices that implement augmented reality (for example, GOOGLE GLASS®). Augmented reality is a live view of a physical, real world environment whose elements are augmented by computer generated sensory input, such as sound, video, graphics, or global positioning system (GPS) data. The controller also has access to and control over various types of equipment (e.g., drilling equipment, logging tools, employee computers). Based on input that it receives from the eyewear devices, the equipment, and resources (e.g., historical data, well logs, geographical data, geophysical data) to which it has access, the controller performs any of a variety of actions. Potential controller actions are wide ranging and may include, without limitation, controlling oilfield equipment or eyewear devices, providing information to users of oilfield equipment or of eyewear devices, and communicating with other electronic devices via a network. Because employees regularly or constantly wear the eyewear devices, output from the controller is seamlessly provided to the user of the eyewear devices in real time, and input (e.g., images, sound, video, tactile input) is seamlessly collected using the eyewear devices and provided to the controller in real time. Additionally, in some applications, computer displays may be programmed to interact with the eyewear devices so as to provide the users of the eyewear devices with the ability to interact with and obtain additional information from the displays.

Additionally, such technology also may include networked automation and control equipment with the capacity to receive and transmit live job data on site and off site. In some embodiments, an automated control system may include automation hardware and software enabled for both local and off site operation. The automated control system may be able to control equipment at a site such that the system can operate the equipment based on a set of instructions that are created at the site or at an off site location. In one or more embodiments, the automated control system is given instructions from an operator or individual at a site.

In other embodiments, the automated control system is disposed about a site and receives instructions from a user at a “virtual real time operation center” (hereinafter “center”). Such a center with associated collaboration software may allow remote on site experts access to all of the previously mentioned technology in real time and the ability to collaborate with multiple off site and on site coworkers during job execution. For example, such network automation and control equipment may allow experts located at a remote facility to control equipment located at an oil well site without being physically present at the facility. In other example, augmented reality technology at a remote operations center can allow an expert to be virtually present at a distance oil well or services site by way of the transfer of information between the center and equipment at the site (such as but not limited to wearable devices at the site, cameras, and other sensing equipment). Such augmented reality technology may present real time streaming data and images to the expert, while simultaneously allowing the expert to control and manipulate equipment at the oil well or services site.

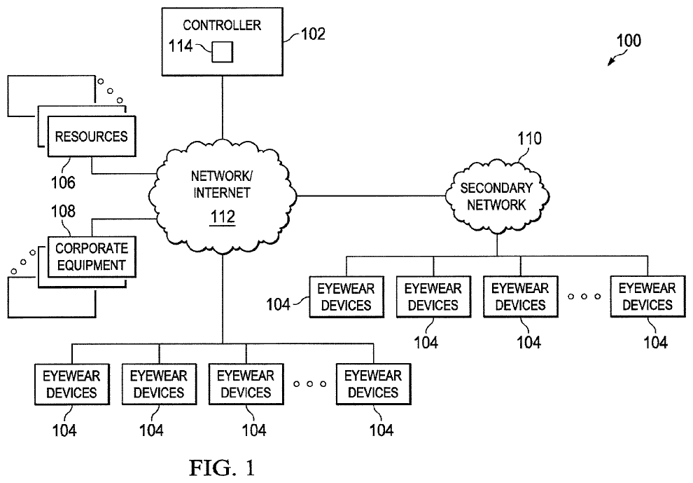

Turning now to the figures, FIG. 1 is a block diagram of an illustrative information collection, processing, and distribution system 100. Although the system 100 may be deployed in any suitable context, this disclosure describes the system in the context of an oil and gas corporation. The system 100 comprises a controller 102 that controls the system 100, a plurality of augmented reality eyewear devices 104, one or more resources 106, corporate equipment 108, and a secondary network 110, all of which communicate with each other by way of a primary network (for example, the Internet) 112. The controller 102 comprises any suitable machine, network of machines, organization of people, or combination thereof that is able to perform the actions of the controller 102 described herein. The system 100 is not limited to these examples.

The network 112 is any suitable computer network that enables multiple computing devices to communicate with each other. It may comprise, without limitation, the Internet, a virtual private network, a local area network, a wide area network and/or any other such network or combination of networks. The network 112 may be a public network or a private/restricted network. The secondary network 110 may or may not be the same type of network as the network 112.

The one or more resources 106 are wide ranging and may include any and all types of information that facilitate the operations of the controller 102 and that the controller 102 can access by way of a network. The one or more resources 106 may be stored on various types of storage (for example, servers that are not specifically shown) and may include, without limitation, wellbore data, drilling logs, well logs, geological data, geophysical data, historical data of all kinds, equipment data, databases, software applications, workflows, corporate policies and procedures, personnel data and directories, specific persons, and other such types of information. The one or more resources 106 may be co-located or they may be distributed across various locations. The corporate equipment 108 includes any and all equipment whether physical (for example, drilling equipment, wireline tools, employee computers, gauges, meters, valves) or virtual (for example, software applications)—that can be controlled remotely by the controller 102 or the eyewear devices 104.

The eyewear devices 104 are augmented reality devices that can be worn on the human head in a manner similar to eyeglasses. Although the scope of this disclosure is not limited to any particular type or brand of eyewear devices, in at least some embodiments, the eyewear devices 104 comprise GOOGLE GLASS® devices. As explained above, augmented reality is a live view of a physical, real world environment whose elements are augmented by computer generated sensory input, such as sound, video, graphics, or global positioning system (OPS) data. Thus, in the system 100, an eyewear device 104 permits the user to see his surroundings as he normally would, but it also projects virtual images toward the user's eye that augments the user's field of vision with additional information that may be useful to the user. This augmented information may include information provided by the controller 102, one or more other eyewear devices 104, corporate equipment 108, or any other suitable source. In addition to receiving and displaying information to a user of the eyewear devices 104, the eyewear devices 104 may collect information and provide it to other systems and devices coupled to the network 112, such as the controller 102 and corporate equipment 108. The eyewear devices 104 may obtain such information by, e.g., capturing images, video, sound, and/or tactile input from a user.

In some embodiments, the eyewear devices 104 communicate wirelessly with the controller 102. The term “wirelessly” is not intended to suggest that the communication pathway between the controller 102 and the eyewear devices 104 is entirely devoid of wires; rather, the terms “wireless” and “wirelessly,” as used herein, mean that the eyewear devices 104 themselves connect to a network (for example, the Internet) without the use of wires to at least some extent for example and without limitation, through a WiFi connection to a wireless access point, a cellular data connection (for example, 3G/4G), or a Bluetooth connection.

Although this disclosure describes the use of eyewear devices, any wearable device may be used, including eyewear, helmets, implantable devices, wristbands, or smartwatches, etc. All such wearable devices will have some or all of the attributes ascribed to the eyewear devices herein, and will at a minimum have the attributes necessary to perform the actions described herein. All such wearable devices are contemplated and included within the scope of the disclosure.

In operation, executing the software 114 causes the controller 102 to obtain information from one or more of the eyewear devices 104, the one or more resources 106, and the corporate equipment 108 and, after considering all information available to it, to perform one or more actions. For instance, a rig hand wearing an eyewear device 104 may notice that a particular instrument on the rig is in an unsafe state and that the instrument must be shut off to avoid an accident. Accordingly, the rig hand may use voice or tactile input to the eyewear device 104 to alert the controller 102 about the unsafe condition. The controller 102, in turn, may use GPS and any other useful information (e.g., images captured using the eyewear device 104 camera) to determine the rig hand's precise location. The controller 102 may then access one or more resources 106 to determine, for instance, the appropriate safety procedure to follow in this particular situation. Having obtained relevant information from the eyewear device 104 and the one or more resources 106, the controller 102 communicates with the unsafe instrument and causes it to shut off. As one of ordinary skill will understand, the software 114 is designed to enable the controller 102 to act appropriately within the context of the particular environment (for example, corporation) in which the controller 102 is deployed.

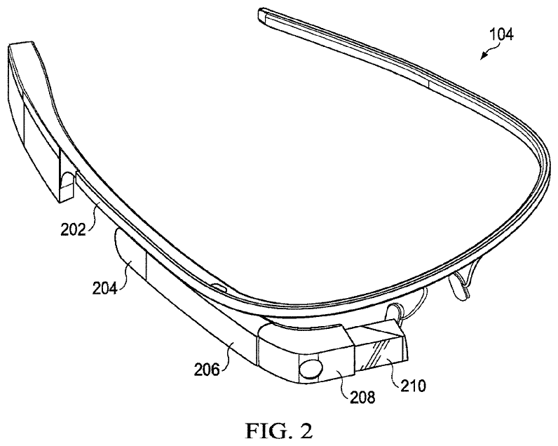

FIG. 2 is a perspective view of an eyewear device 104. The eyewear device 104 comprises a frame 202, a power housing 204, a computer housing 206, a visual equipment housing 208, and a prism 210. The power housing 204 houses a power source, such as a battery, that provides power to electronics coupled to the device 104. The computer housing 206 houses various circuit logic, including processing logic, GPS unit, speaker, microphone, tactile input unit, network transceiver, and storage. In some embodiments, the tactile input unit detects tactile input when the user touches the outer casing of the computer housing 206 with one or more fingers, although other techniques for detecting tactile input are contemplated. The visual equipment housing 208 houses a camera to capture images and a projector to display virtual images to the user's eye via the prism 210.

In one embodiment, when used by operators at a site, the eyewear allows operators to see key equipment parameters at all time on their heads up display. Such parameters include but are not limited to temperature, pressure, rate, and density. Such eyewear could include visual information about equipment within the operators field of view and audible conversations with remotely located experts. In short, this disclosure allows for the ability to link the operator to real time operational information about the equipment.

This disclosure differs from previous technology at least because this disclosure allows information from a machine to be transmitted directly to the operators eyewear. On existing equipment, data is visible only from a fixed location such as a computer at the viewing stand. Here, there is no significant or substantial equipment between the eyewear and the machine sending data at the site.

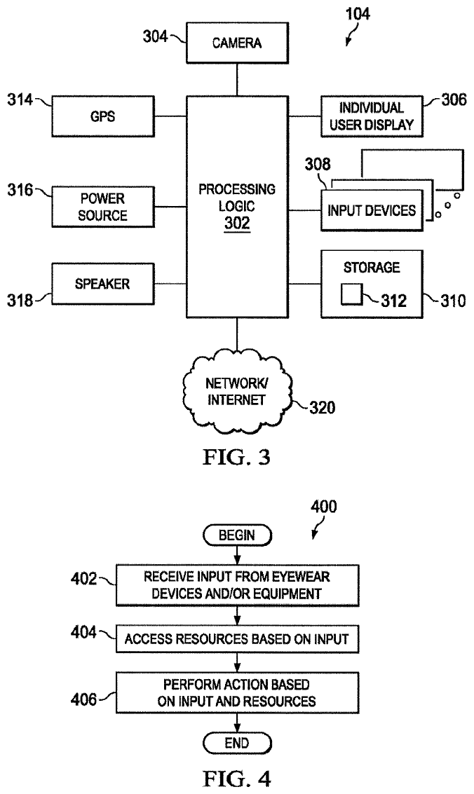

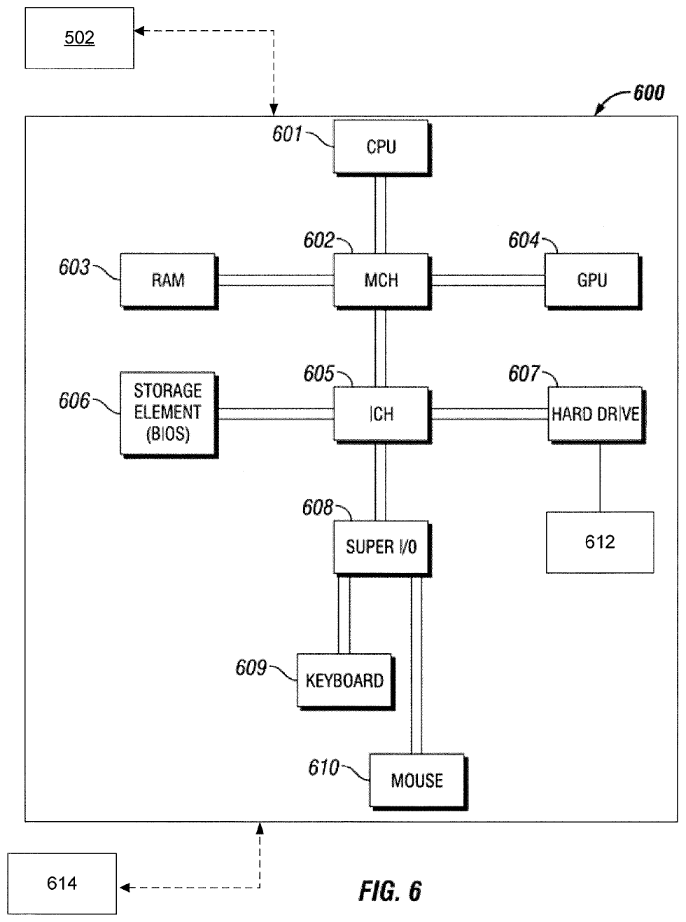

FIG. 3 is a block diagram of components within an eyewear device 104. The eyewear device 104 comprises processing logic 302 (for example, one or more processors), a camera 304, an individual user display 306 (for example, a projector and the prism 210), one or more input devices 308 (for example, tactile input unit, microphone), storage 310 storing software 312 that the processing logic 302 executes to perform the functions of the eyewear device 104, a GPS unit 314, a power source 316, a speaker 318, and a network adapter 320. In one or more embodiments, processing logic 302, storage 310, and one or more other components of FIG. 3 may be part of or included in an information handling system, such as information handling system 600 of FIG. 6. In operation, the power source 316 powers the processing logic and all other components of the eyewear device 104 that require power. The GPS unit 314 determines the coordinates of the location of the eyewear device 104 and provides them to the processing logic 302. The processing logic 302 provides audio output to the speaker 318, which provides the audio output to the user of the eyewear device 104. The network adapter 320 enables the processing logic 302 to communicate wirelessly with one or more other electronic devices (e.g., the controller 102) via a network, such as the Internet. The storage 310 stores the software 302 as well as other data that the processing logic 302 may access (for example, images, audio files). The input devices 308 enable the user to interact with the eyewear device 104. For instance, the user may use tactile input or voice commands to select from one of multiple options presented to him via the speaker 318 or the individual user display 306. The individual user display 306 provides all visual information from the processing logic 302 to the user's eye. The camera 304 captures images of objects appearing in front of the camera 304 and provides the images to the processing logic 302 for further suitable use.

FIG. 4 is a flow diagram of a method 400 that the controller 102 uses to control the system 100. The method 400 comprises receiving input from the eyewear devices 104, and/or corporate equipment 108 (step 402). As described above, such input from the eyewear devices 104 may include images captured using the camera 304, input devices 308 and/or GPS 314. In the case of corporate equipment 108, the input may include, without limitation, instrument readings, logging data, and any other data that may be communicated between physical or virtual equipment and the controller 102. The method 400 further comprises accessing one or more resources 106 based on the input received during step 402 (step 404). As explained, the one or more resources 106 are wide ranging and may include, without limitation, well logs, geological data, geophysical data, historical data of all kinds, databases, software applications, workflows, corporate policies and procedures, personnel data and directories, specific persons, other such types of information and any combination thereof. The method 400 also comprises performing one or more actions based on the input received during step 402 and the resources accessed during step 404 (step 406). Such actions are wide ranging and may include, without limitation, accessing and controlling any eyewear device 104, one or more resources 106, corporate equipment 108, and/or any other device with which communication may be established via the network 112. The method 400 is not limited to the precise set of steps shown in FIG. 4, and steps may be added, deleted or modified as may be suitable.

Multiple examples of the operation of the system 100 are now provided. These examples are merely illustrative, and they do not limit the scope of this disclosure in any way. In one example, the controller 102 leverages the GPS technology embedded within the eyewear devices and potentially in other devices within the corporation to maintain location data for all employees and inventory (for example, equipment, products). For instance, the GPS units in the eyewear devices may periodically transmit GPS coordinates to the controller 102 so that the controller is regularly updated on the position of each eyewear device within the corporation. Similarly, all suitable types of equipment and inventory may be equipped with GPS technology so that the controller 102 is regularly updated on the position of all such equipment and inventory within the organization. The controller can provide such inventory tracking information to certain users of the eyewear devices on a need-to-know basis. For instance, an employee who is expecting a package from another one of the corporation's offices may receive regular, real time updates by way of his eyewear device on the status of his shipment. Such updates may include, for example, current location and estimated time of arrival. The controller may determine this information by combining the GPS data it receives with resources it can access (for example, information from shipping companies, traffic information).

In another example, the drilling of a particular well may be subject to multiple constraints, including financial constraints, equipment constraints, equipment supply constraints, wellbore constraints, geological and geophysical constraints, and legal constraints. The controller 102 may be informed of these constraints by one or more of the eyewear devices 104, the one or more resources 106, and/or the corporate equipment 108. The controller 102 may also access historical data (e.g., formation material properties, well logs) that relates to the drilling of the well from the one or more resources 106. Further still, the controller 102 may also access other types of information from the eyewear devices 104, the one or more resources 106, and/or the corporate equipment 108. For example, a drilling engineer using an eyewear device 104 may provide his expert input on the well drilling project. The controller 102 then formulates an optimized drilling plan based on the collected information. As suggested above, the precise manner in which the controller 102 formulates the drilling plan or performs any other action is dependent on the software 114, which has been written by one of ordinary skill in the art in a manner suitable for the particular corporation within which the system 100 is deployed. One of ordinary skill in the art will recognize suitable ways in which the controller 102 may be programmed to perform drilling optimization tasks or any other task.

In another example, users of the eyewear devices 104 communicate with each other or other computer users that are in communication with the network 110 and/or network 112. In one such application, two employees of the corporation—each of whom is located in a different city may wish to collaborate on a particular wireline tool project. Specifically, one of the employees (“employee A”) may have on his desk a paper based schematic that he wishes to share with his colleague (“employee B”). The employees may each don their respective eyewear devices 104 and establish a private communication session between themselves. Such a private session may be facilitated, for instance, by the controller 102. During the private session, employee A may train his eyewear device's camera on the paper schematic in front of him, thereby providing employee B with a virtual view of the paper schematic that is projected onto his eye using prism 210. Any actions that employee A takes for instance, sketching on the paper schematic by hand—be seen by employee B by way of the image being projected onto his eye by his eyewear device. In turn, employee B may provide feedback to employee A by speaking directly to employee A using his eyewear device, by providing tactile input to his eyewear device, or even by attempting to “write” on the virtual image of the schematic that appears to be in front of him—actions that would be detected by the camera on employee B's eyewear device and provided to employee A by way of employee A's eyewear device. In this way, employees A and B may collaborate efficiently, seamlessly, and in real time.

In another example, each of the eyewear devices 104 may be assigned a “role” that determines what information is and is not shown to the user of that eyewear device. The role to which a particular eyewear device is assigned depends on the user of the device. The eyewear device may be programmed to request login credentials from the user of the eyewear device so that the appropriate role may be used while that user wears the eyewear device. In some embodiments, the eyewear device performs a retinal scan of the user's eye to determine the user's identity and, therefore, the role that should be used. A table cross referencing user identities and corresponding roles (with associated information access privileges) may form part of software 312 or may be stored in a remote location wirelessly accessible by the eyewear device 104.

For instance, a high ranking senior executive of a corporation using the eyewear devices may have high security clearance and thus may be assigned a role that has access to any and all information pertaining to the corporation. He may tailor his role, however, so that despite his high security clearance he is provided with only information that is directly relevant to his position, to a particular project, to a particular group within the corporation, or to some other specific subject. Conversely, the eyewear device of a cement engineer may be assigned a low security clearance role, and the cement engineer may tailor his role so that he controls the type and amount of information with which he is provided. Roles may be grouped so that certain information that is transmitted by the controller 102 or by a particular eyewear device 104 is sent to a single eyewear device 104 or a group of eyewear devices 104. In this way, information can be distributed on a “need-to-know” basis. Thus, for instance, a team manager may transmit inputs to his eyewear device 104 (e.g., video, images, audio) to the eyewear devices of his team of engineers only. Similarly, the “action” that the controller 102 performs in a particular situation after considering all available information and resources may include controlling and/or providing information to one or more eyewear devices based on the eyewear devices' specific roles. Different roles may be assigned, for example and without limitation, to a drilling mud engineer, a cement engineer, a completion engineer, a drill bit engineer, data logging personnel, measurement while drilling personnel, directional drilling engineers, human safety personnel, environmental safety personnel, drilling rig personnel, geologists, geophysicists, rock mechanic specialists, managers, and executives. In addition, different people having the same job title may be assigned different roles; for instance, different cement engineers may be assigned different roles based on their seniority, office location, and any other such factors.

In still another example, a particular employee may use his eyewear device's role to access one or more resources 106 that assist him in performing his duties. For instance, a rig hand may use his eyewear device to access an employee manual that provides a workflow that trains or assists the rig hand in performing a particular task, or, alternatively, the controller 102 may provide a workflow to the rig hand's eyewear device. The workflow may be provided to the rig hand's eyewear device in any suitable format. For example, the rig hand may be given step by step instructions on performing the task by text, audio, and/or image or video based demonstrations. If necessary, the rig hand may use his eyewear device to contact technical support personnel, who may use their own eyewear devices to visualize what the rig hand is seeing at his work site and may assist him by, for example, speaking with him using the eyewear devices.

In some embodiments, roles may be leveraged to enable eyewear device users to interact with computer displays and to view additional information relating to the displays based on their roles. Specifically, in such embodiments, a computer display displays an image that contains one or more “dynamic icons.” A dynamic icon is an image—such as a QUICK RESPONSE® code or any other suitable type of bar code containing information that an eyewear device can interpret based on its role and use to provide additional, role specific information to the eyewear device's user. The information embedded within the dynamic icon is dynamic in the sense that it can be updated as frequently as desired (e.g., at least once per hour). The software 312 contains code that enables the eyewear device to distinguish a dynamic icon from areas of an image that do not constitute a dynamic icon. In this way, an eyewear device executing software 312 is able to identify, capture, and interpret a dynamic icon and perform an action accordingly. Because each eyewear device interprets dynamic icons based on role specific software 312, multiple eyewear devices may interpret the same dynamic icon in different ways. In some cases, a particular dynamic icon may be of no interest to a particular role. In such cases, the eyewear device takes no action as a result of interpreting that particular dynamic icon.

In some embodiments, interpreting the dynamic icon may cause the eyewear device to provide its user with some role specific information (for example, text, image, video, or audio) that is embedded directly within the dynamic icon. In some embodiments, the dynamic icon may contain a reference (for example, a link) to a remotely located source (for example, to a website or FTP site) from which the eyewear device accesses information that is then provided to the user. In some embodiments, the reference may simply be to supplement information that is already stored on the eyewear device. In some embodiments, the information that the eyewear device displays to its user is a function of the data that is embedded within the dynamic icon. For instance and without limitation, the dynamic icon may contain parameters that the eyewear device uses to calculate a different parameter, which is then displayed to the user. Determining the function of the data embedded within the dynamic icon may, in some embodiments, include accessing other resources (for example, the cloud, one or more resources 106). The scope of disclosure is not limited to the specific embodiments described above. In general, the information embedded within the dynamic icon may cause the eyewear device to perform any action. All such actions are encompassed within the scope of this disclosure.

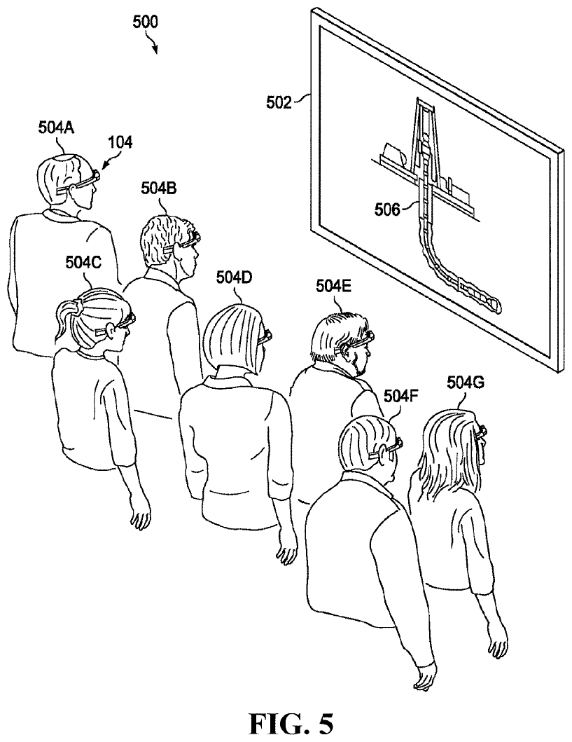

FIG. 5 is a perspective view of an illustrative environment 500 in which the information collection, processing, and distribution system 100 may be deployed. The environment 500 includes a computer display 502 of any suitable size and type that displays an image 506. The environment 500 also includes multiple employees 504A-504G, each of whom wears an eyewear device 104. Each of the eyewear devices 104 in the environment 500 is associated with a different role. The software 312 in each of the eyewear devices 104 determines the role associated with that eyewear device 104.

In operation, the display 502 displays the image 506, which includes one or more dynamic icons that are updated one or more times by the computer that drives the display 502. Each of the eyewear devices 104 worn by users 504A-504G is programmed with software 312 to interpret the dynamic icons in the image 506. For example, when user 504A views the image 506, he sees the image 506 as it appears on the display 506 but, in addition, his eyewear device 104 augments the image 506 by projecting additional information toward his eye. Thus, he sees image 506 and additional information that appears as an additional layer of information in front of the image 506. The additional information is provided to user 504A as a result of his eyewear device 104 interpreting one or more dynamic icons present in the image 506. In some embodiments, the user 504A may then interact with the additional information. For instance, he may use a finger to interact with the virtual image that appears before him, and the camera coupled to his eyewear device 104 captures, processes and responds to his interactions as software 312 permits. Alternatively or in addition to such interaction, the user 504A may issue voice commands and/or provide tactile input that is captured and processed by his eyewear device 104. These interactions are merely illustrative and they do not limit the scope of disclosure.

In some embodiments, the eyewear device 104 of user 504A interprets a dynamic icon and performs an action in response to the dynamic icon, but it provides no information to the user 504A. In some embodiments, the eyewear devices 104 interpret the same dynamic icon(s) in different ways because each of the eyewear devices 104 is associated with a different role. For instance, the user 504A may wear an eyewear device 104 that performs an action as a result of interpreting a particular dynamic icon. In contrast, the user 504B may wear an eyewear device 104 that performs no action at all after interpreting the same dynamic icon, because that dynamic icon may be irrelevant to the user 504B. Similarly, users 504C-504G all may use eyewear devices 104 that react differently to the same dynamic icon.

FIG. 6 is a block diagram of an information handling system 600 associated with a display, for example, display 502. In one or more embodiments, information handling system 600 may be directly or indirectly, wired or wireless, coupled to display 502 and may be proximate to or remote from display 502. In one or more embodiments, display 502 may be a smart display (for example, a touch screen or a smart phone) that allows for two way communication between the display 502 and the information handling system 600. Any information handling system and any component discussed that includes a processor may take a form similar to the information handling system 600 or include one or more components of information handling system 600. A processor or central processing unit (CPU) 601 of the information handling system 600 is communicatively coupled to a memory controller hub (MCH) or north bridge 602. The processor 601 may include, for example a microprocessor, microcontroller, digital signal processor (DSP), application specific integrated circuit (ASIC), or any other digital or analog circuitry configured to interpret, execute program instructions, process data, or any combination thereof. Processor (CPU) 601 may be configured to interpret and execute program instructions, software, or other data retrieved and stored in any memory (for example, memory 603 or hard drive 607), for example, instructions 612. Program instructions or other data may constitute portions of a software or application for carrying out one or more methods described herein. Memory 603 may include read only memory (ROM), random access memory (RAM), solid state memory, or disk based memory. Each memory module may include any system, device, or apparatus configured to retain program instructions, program data, or both for a period of time (e.g., computer readable non-transitory media). For example, instructions from a software or application may be retrieved and stored in memory 603 for execution by processor 601. Modifications, additions, or omissions may be made to FIG. 6 without departing from the scope of the present disclosure. For example, FIG. 6 shows a particular configuration of components of information handling system 600. However, any suitable configurations of components may be used. For example, components of information handling system 600 may be implemented either as physical or logical components. Furthermore, in some embodiments, functionality associated with components of information handling system 600 may be implemented in special purpose circuits or components. In other embodiments, functionality associated with components of information handling system 600 may be implemented in configurable general purpose circuit or components. For example, components of information handling system 600 may be implemented by configured computer program instructions.

Memory controller hub (MCH) 602 may include a memory controller for directing information to or from various system memory components within the information handling system 600, such as memory 603, storage element 606, and hard drive 607. The memory controller hub 602 may be coupled to memory 603 and a graphics processing unit (GPU) 604. Memory controller hub 602 may also be coupled to an I/O controller hub (ICH) or south bridge 605. I/O controller hub 605 is coupled to storage elements of the information handling system 600, including a storage element 606, which may comprise a flash ROM that includes a basic input/output system (BIOS) of the computer system. I/O controller hub 605 is also coupled to the hard drive 607 of the information handling system 600. I/O controller hub 605 may also be coupled to a Super I/O chip 608, which is itself coupled to several of the I/O ports of the computer system, including keyboard 609 and mouse 610. Information handling system 600 may comprise a network interface card, network interface, network adapter, or any other networking module, device or component internally or externally that allows or provides networking capability between information handling system 600 and any other devices, information handling systems, networks, other components, or any combination thereof, for example, network adapter 614.

In one or more embodiments, an information handling system 600 may comprise at least a processor, and a memory device coupled to the processor that contains a set of instructions that when executed cause the processor to perform certain actions. In any embodiment, the information handling system may include a non-transitory computer readable medium that stores one or more instructions where the one or more instructions when executed cause the processor to perform certain actions. As used herein, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a computer terminal, a network storage device, or any other suitable device and may vary in size, shape, performance, functionality, and price. The information handling system may include random access memory (RAM), one or more processing resources such as a central processing unit (CPU) or hardware or software control logic, read only memory (ROM), or any other types of nonvolatile memory. Additional components of the information handling system may include one or more disk drives, one or more network ports for communication with external devices as well as various I/O devices, such as a keyboard, a mouse, and a video display. The information handling system may also include one or more buses operable to transmit communications between the various hardware components.

The processing logic 302 or processor 601 may execute one or more instructions or software 612 to display images on the display 502 as described herein. The processing logic 302 or processor 601 is able to communicate with other electronic devices (for example, eyewear devices 104, controller 102, one or more resources 106, corporate equipment 108) via network adapter 614. Thus, for example, the processing logic 302 or processor 601 may provide information relating to dynamic icons (for example, instructions on interpreting dynamic icons) to one or more eyewear devices 104. Similarly, eyewear devices 104 may communicate with the processing logic 302 or processor 601 to interact with the image shown on display 502. For instance, the eyewear device 104 of user 504A may interpret a dynamic icon and may display additional information to user 504A as a result. The user 504A may provide input to his eyewear device 104 in an effort to interact with the additional information displayed to him. These interactions may cause the eyewear device 104 to modify the additional information that it displays to him. Alternatively or in addition, these interactions may cause the eyewear device 104 to effectuate changes to the image shown on display 502 by communicating with the processing logic 302 or processor 301. All such variations in interactions and communications between the various electronic devices disclosed herein are contemplated and fall within the scope of this disclosure.

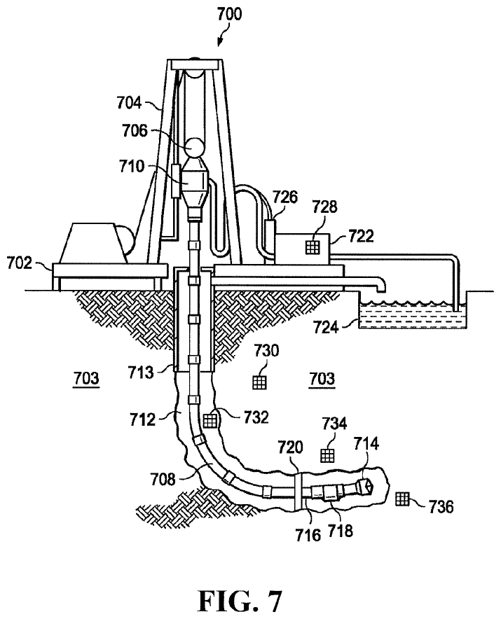

FIG. 7 is an image 700 such as that which may be displayed on the display 502 of FIGS. 5 and 6. As explained below, the image 700 also comprises multiple dynamic icons. The image 700 shows a drilling platform 702 that supports a derrick 704 having a traveling block 706 for raising and lowering a drill string 708. A top drive motor 710 (or, in other embodiments, a rotary table) supports and turns the drill string 708 as it is lowered into the borehole 712. The drill string's rotation, alone or in combination with the operation of a downhole motor, drives the drill bit 714 to extend the borehole. The drill bit 714 is one component of a bottomhole assembly (BHA) 716 that may further include a rotary steering system (RSS) 718 and stabilizer 720 (or some other form of steering assembly) along with drill collars and logging instruments. A pump 722 circulates drilling fluid through a feed pipe to the top drive 710, downhole through the interior of drill string 108, through nozzles in the drill bit 714, back to the surface via the annulus around the drill string 108, and into a retention pit 724. The drilling fluid transports drill cuttings from the borehole 712 into the retention pit 724 and aids in maintaining the integrity of the borehole. An upper portion of the borehole 712 is stabilized with a casing string 713 and the lower portion being drilled is an open (uncased) borehole. A surface interface 726 serves as a hub for communicating via a telemetry link and for communicating with the various sensors and control mechanisms on the platform 702. The image 700 also comprises multiple dynamic icons 728, 730, 732, 734, and 736.

While FIG. 7 illustrates a land based rig environment, the present disclosure contemplates any one or more embodiments implemented at a well site at any location, including at sea above a subsea hydrocarbon bearing formation.

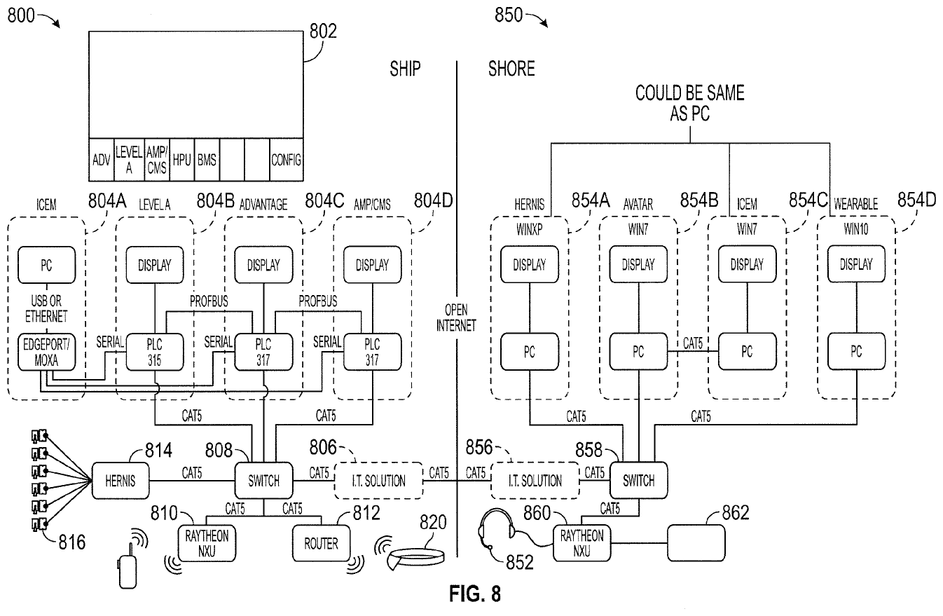

FIG. 8 a flowchart of a multi-location virtual collaboration, monitoring, and control of one or more drilling operations for a site, according to one or more aspects of the present disclosure. In the following disclosure, FIG. 8 is described as being disposed, positioned or otherwise located on or about a ship. However, in some embodiments, such equipment and techniques may be used for ground sites. In other embodiments, such equipment may be found on or near the surface of the ocean, or even on the ocean floor.

An automated control system 800 disposed about a site may comprise a centralized multi-equipment consolidated user interface 802, also called a display application, that combines all the user interfaces for all the individual pieces of hydrocarbon recovery, exploration, operation or services equipment installed at the sites, which may include but are not limited to ships at sea. The consolidated user interface may receive data from at least one of the communicably coupled pieces of equipment disposed about the sites, thereby allowing an operator to see the operation parameters of the equipment pieces. Also, the consolidated user interface may allow an operator to send commands to the communicably coupled pieces of equipment, thereby controlling the equipment from the consolidated user interface.

In some embodiments, some equipment pieces may include, but is not limited to, Level A Remote Pressure Test Equipment, an Advantage Skid Mixing and Pumping Unit, an AMP/CMS liquid additive systems, a HPU Hydraulic Power Unit, and a BMS Bulk Monitoring System. The consolidated user interface 802 may be operable from any of the local displays 804A, 804B, 804C, and 804D available on each specific piece of equipment. For example, one may operate the AMP/CMD 804D, BMS and Level A (804B) systems from the display on the Advantage unit 804C. This application is installed and operates on each of the Display blocs shown inside 804B, 804C, and 804D.

In some embodiments, equipment may include the cementer's personal computer (PC) operating iCEM software may collect all job data via the Moxa Edgeport device that is gathering data from multiple PLC's (or other controllers or instruments) located in for recording live job data from the Level A 804B, Advantage 804C, AMP/CMS 804D, BMS (not shown), or any other kind of equipment that the operator or user needs to collect information from that pertains to the operation of a site.

The user interface may be located in a safe location, such as a remote viewing room, and may allow an operator or user to conduct well pressure tests away from pressurized lines and equipment. In some embodiments, the equipment called iCEM job recording software may be a main method of providing job performance and results to customers of the site. In some embodiments, the equipment called Level A system 804B may be a remote pressure testing system. In some embodiments, the equipment called advantage system 804C may be the cement mixing and pumping unit used to mix and pump cement, or any other desired fluids, downhole. In some embodiments, the equipment called the AMP/CMS system 804D is the liquid additive system. Equipment like the AMP/CMS system 804D is common in the industry because additives are commonly injected into the mix water or the cement stream prior to pumping the fluids down the well.

Equipment pieces 804A, 804B, 804C, and 804D may be coupled to ethernet switch 808 that provides multiple Ethernet connections for connecting multiple pieces of equipment together for information sharing. In some embodiments, also connected to ethernet switch 808 is equipment called the Ship IT Solution 806 (i.e. network) for transmitting data from the site, which may be a ship, to a center 850 with knowledge experts and customers. In some embodiments, also connected to ethernet switch 808 is equipment called Raytheon NXU 810, which is a voice over internet device that allows wireless radio and headset voice and audio to be compressed and sent via a network protocol to a remote location. In some embodiments, also connected to ethernet switch 808 is equipment called a local router or wireless access point 812 that allows wearable devices 820 like an Augmented Reality Headset to make a connection to the internet for sharing and displaying information with other equipment and users; in particular those located at the remote location, which may be on shore. In some embodiments, wearable devices 820 may be worn by equipment operators or users on site while operating equipment and collaborating with users at center 850.

In some embodiments, also coupled to ethernet switch 808 may be equipment called Hernis 814, which is a camera system that takes multiple camera feeds and converts them to live internet video streams that can be delivered via a network to remotely located users, operators or knowledge experts. In some embodiments, HERNIS is an equipment camera system shows video streams of various locations on the equipment pieces for the purpose of monitoring. Additional equipment cameras 816 may be coupled to Hermis 814.

A hydrocarbon recovery, exploration, operation or services virtual collaboration, monitoring and center 850 may comprise an audio headset 852 worn by operators, users, knowledge experts, other individuals or both at the remote operations center 850. In some embodiments, audio headsets 852 may include augmented reality displays as well. In some embodiments, Hernis Video 854A streams footage from cameras mounted on equipment located at the site. In some embodiments, video streams may arrive via Hernis system 814 and be delivered via network to the center 850 where the information is displayed 854A. In some embodiments, equipment called Avatar 854B may be a software and hardware solution allowing remote knowledge experts to collaborate with on site equipment operators, or users at a center, via augmented reality head sets and live audio and video feeds transferred from automated control system 800 to center 850 via internet/network. In some embodiments, the equipment called iCem 854C consists of live job data collection that may be recorded at center 850 using iCEM in similar fashion as it is used at job site (reference 804A). This information is then used to report job execution and performance to customers. In some embodiments, wearables 854D may be used by individual remote site collaborators for the purpose of sharing and viewing data, audio and video with Ship side operators.

In some embodiments, the equipment called remote site IT Solution 856 (for example a network) may allow for data sharing and collaboration between a center 850 and automated control system 800 via coupling to IT Solution 806, thereby allowing for communication with experts located at a center 850. In some embodiments, the equipment called ethernet switch 858 provides multiple Ethernet connections for connecting multiple pieces of equipment together for information sharing. In some embodiments, the equipment Raytheon NXU 860 is a voice over internet device that allows wireless radio and headset voice and audio to be compressed and sent via a network protocol to a remote location, such as virtual remote operation center. In some embodiments, equipment called conference room speaker and microphone 862 allows for conversations between multiple individuals at center 850 and automated control system 800, thereby allowing everyone in room can hear and speak with operators disposed about the automated control system 800 or users disposed about a center 850.

In some embodiments, Raytheon NXU 860 may also couple to a command system 862. In some embodiments, equipment called command system 862 may be an expert intermediary with expertise regarding one or more operations required by the site, or a robot, or an information handling system or other computer device, or any other processing system or personnel, or any combination thereof.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. It should be understood that various changes, substitutions and alterations can be made herein without departing from the spirit and scope of the disclosure as defined by the claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee. The indefinite articles “a” or “an,” as used in the claims, are each defined herein to mean one or more than one of the element that it introduces.

What is claimed is:

1. A virtual real time operation and collaboration system comprising:
a virtual real time operation center;
a hydrocarbon recovery, exploration, operation or services environment site;
one or more equipment at the hydrocarbon recovery, exploration, operation or services environment site,
wherein the equipment at least one of measures real time data and records one or more images from the at least one hydrocarbon recovery, exploration, operation, or services environment site,
wherein the equipment transmits the at least one of the real time data and the one or more images to the virtual real time operation center; and
at least one automated control system disposed at the hydrocarbon recovery, exploration, operation, or services environment site,
wherein the at least one automated control system at least one of controls at least one of the one or more or allows an individual at the virtual real time operation center to control at least one of the one or more equipment.

2. The system of claim 1, wherein the hydrocarbon recovery, exploration, operation services environment site is above a subsea hydrocarbon bearing formation.

3. The system of claim 2, wherein the one or more equipment pieces is disposed about a ship.

4. The system of claim 1, wherein the at least one of the one or more equipment comprises a wearable device.

5. The system of claim 2, wherein the wearable device is an eyewear device worn by an operator at the hydrocarbon recovery, exploration, operation, or services environment site.

6. The system of claim 1, further comprising:
a centralized multi-equipment consolidated user interface that combines the real time data and the one or more images from a plurality of the one or more equipment pieces; and
a display on the centralized multi-equipment consolidated user interface, wherein the display allows an operator at the hydrocarbon recovery, exploration, operation or services environment site to view the real time data and the one or more images from the plurality of the one or more equipment.

7. The system of claim 1, further comprising:
an augmented reality device disposed at the virtual real time operation center that allows a user at the virtual real time operation center to view the at least one of the real time data and the one or more images transmitted by the equipment at the hydrocarbon recovery, exploration, operation, or services environment site.

8. The system of claim 7, wherein the augmented reality device displays simultaneously to the user the information from a plurality of the one or more equipment pieces disposed about a plurality of hydrocarbon exploration, operation, or services environment sites.

9. The system of claim 8, wherein the augmented reality device is a wearable device worn by a user at the virtual real time operation center.

10. An automated control system comprising:
a hydrocarbon recovery, exploration, operation or services environment site;
a plurality of equipment pieces disposed about the site; and
a centralized multi-equipment consolidated user interface disposed about the site and communicably coupled to each of the plurality of equipment pieces,
wherein the plurality of equipment pieces send data to the user interface.

11. The system of claim 10, wherein the hydrocarbon recovery, exploration, operation services environment site is above a subsea hydrocarbon bearing formation.

12. The system of claim 10, wherein the centralized multi equipment consolidated user interface is in a viewing room disposed about the site.

13. The system of claim 10, wherein each of the plurality of pieces of equipment further comprise a local display and the centralized multi-equipment consolidated user interface is operable from any of the local displays.

14. The system of claim 10, wherein the pieces of equipment are coupled to an ethernet switch, which in turn is coupled to at least one piece of information sharing equipment.

15. The system of claim 13 wherein the information sharing equipment includes at least one voice over internet device that allows for communication by an operator to a virtual remote operation center.

16. A remote monitoring and collaboration method comprising:
directing at least one device at a hydrocarbon recovery, exploration, operation or services environment site to at least one of measure real time data and record one or more images from the hydrocarbon recovery, exploration, operation or services environment site;
receiving at a virtual real time operation center the at least one of the real time data and the one or more images from the hydrocarbon recovery, exploration, operation or services environment site;
displaying the at least one of the real time data and the one or more images at the virtual real time operation center at an augmented reality device; and
sending an instruction to an automated system located at the hydrocarbon recovery, exploration, operation or services environment site, wherein the instruction controls one or more equipment pieces located at the site.

17. The method of claim 16, wherein the augmented reality device is a wearable device worn by a user at the virtual real time operation center.

18. The method of claim 17, wherein the wearable device is an eyewear device.

19. The method of claim 16, further comprising displaying the at least one of the real time data and the one or more images from a plurality of hydrocarbon recovery, exploration, operation or services environment sites.

20. The system of claim 16, wherein the hydrocarbon recovery, exploration, operation services environment site is above a subsea hydrocarbon bearing formation.
